(19) United States
(12) Patent Application Publication
(10) Pub. No.: US 2024/0109080 A1
(43) Pub. Date: Apr. 4, 2024

(54) Separation Device for Separating Impurities from Fluid to be Cleaned, Load Determination Apparatus for a Separation Device, and Method for Determining an Impurity Load State

(71) Applicant: MANN+HUMMEL GmbH, Ludwigsburg (DE)

(72) Inventors: Markus BEYLICH, Ludwigsburg (DE); Anthony W. FELL, Yeovil (GB); Vikas Jilakarapalli PRABHAKAR, Taunton (GB)

(21) Appl. No.: 18/522,604

(22) Filed: Nov. 29, 2023

Related U.S. Application Data
(63) Continuation of application No. PCT/EP2022/062148, filed on May 5, 2022.

(30) Foreign Application Priority Data
Jun. 1, 2021 (EP) 21177043.3

(51) Int. Cl. B04B 7/16; B04B 9/10

(52) U.S. Cl. CPC B04B 7/16; B04B 9/10; B04B 2013/006

(57) ABSTRACT

A separation device for separating impurities from a fluid to be cleaned has a separation body with a collecting region for impurities. A load determination apparatus determines an impurity load state of the collecting region for impurities. The load determination apparatus has a transmitter emitting electromagnetic waves, a receiver receiving the electromagnetic waves emitted by the transmitter, and an evaluation device. Transmitter and receiver are arranged opposite each other on opposite sides of the collecting region for impurities. The separation body at least in sections is at least partially transmissive for electromagnetic waves emitted by the transmitter. Transmitter and receiver are connected to the evaluation device. The evaluation device determines the impurity load state of the collecting region for impurities based on the electromagnetic waves received by the receiver. Such a load determination apparatus as described as well as a method for determining an impurity load state are provided.

### CROSS-REFERENCE TO RELATED APPLICATIONS

This application is a continuation application of international application No. PCT/EP2022/062148 having an international filing date of 5 May 2022 and designating the United States, the international application claiming a priority date of 1 Jun. 2021 based on prior filed European patent application No. 21 177 043.3, the entire contents of the aforesaid international application and the aforesaid European patent application being incorporated herein by reference.

### BACKGROUND OF THE INVENTION

The invention concerns a separation device for separating impurities from fluid to be cleaned, with at least one separation body with at least one collecting region in which impurities can collect, and with at least one load determination apparatus by means of which an impurity load state of at least one part of at least one collecting region can be determined.

Furthermore, the invention concerns a load determination apparatus for a separation device for separating impurities from fluid to be cleaned, by means of which an impurity load state of at least one part of at least one collecting region of at least one separation body of the separation device, in which the impurities can collect, can be determined.

In addition, the invention concerns a method for determining an impurity load state of at least one part of at least one collecting region of at least one separation body of at least one separation device for separating impurities from a fluid to be cleaned.

DE 10 2015 005 226 A1 discloses an indicator device for providing information, in particular for emitting a signal, in regard to an impurity load state of a separation device, in particular of a fluid centrifuge, for separating impurities, in particular particles, from a fluid, in particular oil, in particular of an internal combustion engine, in particular of a motor vehicle, a separation device and rotor of a fluid centrifuge. The indicator device comprises at least one working part which can be at least partially changed with respect to its shape and/or its position and which is arranged or can be arranged at least partially in a collecting region of the separation device, in particular of a rotor of the fluid centrifuge, for separated impurities in such a way that it can be at least partially covered, depending on the impurity load state, by separated impurities.

The invention is based on the object of designing a separation device, a load determination apparatus, and a method of the aforementioned kind in which an impurity load state of the at least one separation body can be determined more reliably.

### SUMMARY OF THE INVENTION

This object is solved according to the invention for the separation device in that the at least one load determination apparatus comprises at least one transmitter for electromagnetic waves and at least one receiver for electromagnetic waves which have been emitted by the at least one transmitter, wherein the at least one transmitter and the at least one receiver are arranged on opposite sides of at least one collecting region for separated impurities of the at least one separation body, wherein the at least one separation body at least in sections thereof is at least partially transmissive for the electromagnetic waves emitted by the at least one transmitter, and wherein the at least one transmitter and the at least one receiver are connected to at least one evaluation device by means of which the impurity load state of the at least one collecting region can be determined based on the electromagnetic waves received by the at least one receiver.

According to the invention, at least one transmitter and at least one receiver for electromagnetic waves are arranged on opposite sides of a collecting region for impurities. With the at least one transmitter, electromagnetic waves are sent through the collecting region and received by means of the at least one receiver. In the collecting region, the electromagnetic waves are damped depending on the quantity of impurities separated thereat, i.e., the impurity load state. Damping which the electromagnetic waves experience upon passing through the collecting region thus relates to the impurity load state. The impurity load state of the at least one collecting region is determined based on damping of the received electromagnetic waves in relation to the emitted electromagnetic waves.

Advantageously, the impurity load state of a collecting region can characterize a degree of loading of the collecting region with impurities. The impurity load state can be specified in this context in the form of a damping level of the electromagnetic waves, as thickness of a so-called cake formed of impurities, or in form of a different quantitative and/or qualitative specification.

By means of electromagnetic waves, the impurity load state can be determined in a contactless manner. No mechanical connection between the load determination apparatus and the at least one separation body is required. In this manner, in case of a moving separation body, in particular a rotor of a centrifugal separator, the movement of the separation body is not impaired by the determination of the load. In this manner, the determination of the load can be realized even for continuing operation of a separation device with a moving separation body.

Various materials, for example, glass, plastic material, metal, water, oil, soot or the like can affect the signal distribution of electromagnetic waves. The invention uses this damping property of various materials on electromagnetic waves. With the invention, damping of electromagnetic waves upon passage through the collecting region, in particular through impurities with which the collecting region is laden, can be determined. A correlation of damping of the electromagnetic waves and of the load of the at least one collecting region can be used for determining a servicing interval for servicing the separation device. By means of the invention, a service indicator can be realized which indicates the impurity load state of the separation device. It can be indicated when the impurity load state has reached a level that requires servicing, in particular cleaning or an exchange of the at least one separation body. In this manner, a service life of the separation device can be extended as a whole. Furthermore, the quality of the fluid to be cleaned can be improved. Thus, devices, in particular motors in which the cleaned fluid is used, can be protected better.

The information in regard to the impurity load state is determined with at least one evaluation device. Advantageously, the at least one evaluation device can be connected to a control unit and/or an output device which can be arranged remote from the separation device, in particular in a control stand or a dashboard of a motor vehicle or the like. The impurity load state can thus be monitored also remote from the separation device. Thus, it is also not required to check the impurity load state of the separation device directly at the separation device as is the case, for example, in the indicator device known from the prior art.

Advantageously, at least one evaluation device can be an electronic evaluation device. In this manner, the impurity load state can be determined, in particular calculated, based on software and/or hardware. Furthermore, the at least one evaluation device can be connected to a corresponding electrical/electronic control unit of a machine, in particular of a motor, in particular of an internal combustion engine, and/or of a vehicle. Corresponding information in regard to the impurity load state of the separation device can be transmitted thus to the control unit and appropriate measures can be initiated.

Advantageously, the output of information, in particular acoustic and/or visual signals, or control functions for a machine, can be initiated by means of the at least one evaluation device and/or at least one control unit.

The load determination apparatus advantageously can be part of an oil centrifuge of an internal combustion engine. The separation device, in particular the oil centrifuge, can advantageously be part of a motor oil circuit of an internal combustion engine. It can serve for cleaning motor oil which is supplied to the internal combustion engine. The invention is however not limited to a separation device of a motor oil circuit of an internal combustion engine. Instead, it can also be used in different separation devices and/or different liquid systems, in particular fuel systems or hydraulic systems, of vehicles, in particular motor vehicles, or other machines. The separation device can be used in automobile technology, in industrial motors or the like.

The separation device can be a separation device for separation of impurities from liquid and/or gaseous fluid. Advantageously, soot particles can be removed from motor oil by means of the separation device.

In an advantageous embodiment, the at least one separation device can be a centrifuge separator comprising at least one rotor which is rotatable about a rotor axis and which comprises a separation wall, which surrounds the rotor axis circumferentially and at whose radially inner circumferential side a collecting region for separated impurities is realized, wherein at least the separation wall at least in sections thereof is at least partially transmissive for the electromagnetic waves. Upon operation of the separation device, the fluid to be cleaned can be brought into the interior of the at least one rotor. Due to the rotation of the at least one rotor, impurities of the fluid to be cleaned, in particular soot particles or the like, can be conveyed radially outwardly due to the centrifugal force. The impurities can be separated in the collecting region at the radially inner circumferential side of the at least one rotor.

The load determination apparatus operates in a contactless manner. In this manner, an impurity load state during the operation, i.e., while the rotor rotates, can be determined. It is not required to stop the separation device while the impurity load state is determined.

The at least one separation wall can be at least partially transmissive at least in sections thereof for the electromagnetic waves. APartially transmissive@ means that the at least one separation wall transmits the electromagnetic waves without damping or with a minimal damping. In this manner, the electromagnetic waves can pass through the at least one separation wall. Thus, the electromagnetic waves in relation to the rotor axis can propagate radially from the interior to the exterior, or in reverse, through the at least one separation wall and, as needed, through the separated impurities. In this way, an impurity load state can be determined in connection with a radial thickness of the separated impurities in relation to the rotor axis.

Advantageously, the separation wall can be at least partially of non-metallic material, in particular plastic composite material, GRP (glass-reinforced plastic) or the like. In this manner, the separation wall can be at least partially transmissive for electromagnetic waves.

In a further advantageous embodiment, at least one transmitter can be arranged in relation to the rotor axis radially outside of the circumferential separation wall and/or at least one receiver can be arranged in relation to the rotor axis radially outside of the circumferential separation wall. A space within the separation wall can thus be used as separation space for separation of the impurity. The at least one transmitter and/or the at least one receiver can be arranged outside of the separation space laden with impurities. In this way, contamination of the at least one transmitter and/or of the at least one receiver by impurities can be avoided. Contamination of transmitter and/or receiver can impair the function of the load determination apparatus. Furthermore, the at least one transmitter and/or the at least one receiver can be mounted more easily outside of the separation wall, in particular of the rotor.

In a further advantageous embodiment, the at least one rotor can comprise a spindle rotatable about the rotor axis on which the separation wall is held so as to be rotatable, and a virtual connection line between at least one transmitter and at least one receiver can extend outside of the spindle. In this manner, the propagation of the electromagnetic waves cannot be impaired by the spindle. The spindle itself can thus be of a material which is not transmissive or only minimally transmissive for electromagnetic waves.

Advantageously, a virtual connection line between the at least one transmitter and the at least one receiver can extend tangentially to a virtual circular cylinder wall coaxial to the rotor axis. In this manner, upon rotation of the rotor, the impurity load state of the collecting region can be determined at a constant axial height in relation to the rotor axis.

In a further advantageous embodiment, the centrifugal separator can comprise at least one rotary speed determination device for determining the rotary speed of the at least one rotor. By taking into account the rotary speed, the impurity load state can be determined more precisely.

In a further advantageous embodiment, at least one electronic evaluation device can be connected to the at least one rotary speed determination device and can comprise means for determining an impurity load state based on the received electromagnetic waves and based on the rotary speed of the rotor. In this way, the impurity load state can be determined electronically based on the rotary speed of the rotor and based on the received electromagnetic waves, respectively the damping of the received electromagnetic waves.

In a further advantageous embodiment, the electromagnetic waves can be radio waves. For producing and receiving radio waves, simple inexpensive and reliably operating transmitters and receivers can be employed. As is known, radio waves are electromagnetic waves whose frequency is below 3,000 GHz. Preferably, frequencies in the range of approximately 1 GHz to 60 GHz are used; frequencies of 2.3-2.5 GHz and/or 5 GHz-5.8 GHz and/or 5.925 GHz-7.125 GHz are used with particular preference.

In a further advantageous embodiment, the electromagnetic waves can be directional. In this manner, the electromagnetic waves can be directed toward the at least one collecting region. In this way, monitoring of the impurity load state can be performed more efficiently. For directional electromagnetic waves, the energy is spatially concentrated, in particular in cross section. The energy can be concentrated on the collecting region. Energy losses in regions which are of no interest outside of the collecting region can be reduced. As a whole, one can work with a reduced transmitting energy as compared to non-directional electromagnetic waves.

In a further advantageous embodiment, at least part of the electromagnetic waves can be permanent signals and/or at least part of the electromagnetic waves can be pulsed signals. Permanent signals have the advantage that a continuous monitoring of the impurity load state can be performed. Pulsed signals have the advantage that, for the same transmitting power, the required transmitting energy as a whole can be reduced because transmitting pauses are provided between the pulses. Alternatively, a corresponding greater transmitting power per signal pulse can be used without having to increase the overall transmitting energy in this way.

In a further advantageous embodiment, at least one transmitter and/or at least one receiver can be arranged at a housing inner side of a housing of the separating device. In this manner, the at least one transmitter and/or the at least one receiver can be mounted fixedly at the housing. For servicing of the separation device, in particular for cleaning and/or for exchange of the at least one separation body, the at least one transmitter and/or the at least one receiver must not be removed.

In a further advantageous embodiment, a microcontroller with integrated transmitting and/or receiving unit is employed as transmitter and/or receiver.

Advantageously, the housing of the separation device can be designed to be openable. In this manner, the at least one separation body can be made freely accessible for servicing purposes.

In particular when using moving separation bodies, as is the case in particular in centrifugal separators, the at least one transmitter and the at least one receiver can be arranged fixedly at the housing and must not be moved together with the at least one separation body.

In an advantageous embodiment, at least one transmitter and/or at least one receiver can be encapsulated fluid-tightly. In this manner, the at least one transmitter and/or at least one receiver can be protected from fluid and/or contamination.

Advantageously, the at least one transmitter and/or the at least one receiver can be encapsulated fluid-tightly in a fluid-conveying region of the separation device, in particular within the housing.

Furthermore, the object is solved according to the invention for the load determination apparatus in that the at least one load determination apparatus comprises at least one transmitter for electromagnetic waves and at least one receiver for electromagnetic waves emitted by the at least one transmitter, wherein the at least one transmitter and the at least one receiver are arranged on opposite sides of at least one collecting region for separated impurities of the at least one separation body, wherein the at least one separation body at least in sections thereof is at least partially transmissive for the electromagnetic waves emitted by the at least one transmitter, and wherein the at least one transmitter and the at least one receiver are connected to at least one evaluation device by means of which the impurity load state of the at least one collecting region can be determined based on the electromagnetic waves received by the at least one receiver.

In addition, the object is solved according to the invention for the method in that electromagnetic waves are sent by at least one transmitter through at least one collecting region of the at least one separation body for separated impurities, the electromagnetic waves passing through the at least one collecting region are received by at least one receiver at the side which is opposite the transmitter in relation to the collecting region, and an impurity load state of the at least one collecting region is determined based on the received electromagnetic waves by means of at least one evaluation device.

In other respects, the features and advantages which have been disclosed in connection with the separation device according to the invention, the load determination apparatus according to the invention, and the method according to the invention and their respective advantageous embodiments apply correspondingly among each other and vice versa. The individual features and advantages can be combined, of course, among each other, wherein further advantageous effects may result that go beyond the sum of the individual effects.

### BRIEF DESCRIPTION OF THE DRAWINGS

Further advantages, features, and details of the invention result from the following description in which embodiments of the invention will be explained in more detail with the aid of the drawing. A person of skill in the art will consider the features disclosed in combination in the drawing, the description, and the claims also expediently individually and combine them to expedient further combinations.

FIG. 1 shows schematically a longitudinal section of an oil centrifuge of a motor oil circuit of an internal combustion engine which comprises a load determination apparatus for determining an impurity load state of a rotor of the oil centrifuge caused by separated soot.

FIG. 2 shows a cross section of the oil centrifuge of FIG. 1.

In the Figures, same components are provided with same reference characters.

### DESCRIPTION OF PREFERRED EMBODIMENTS

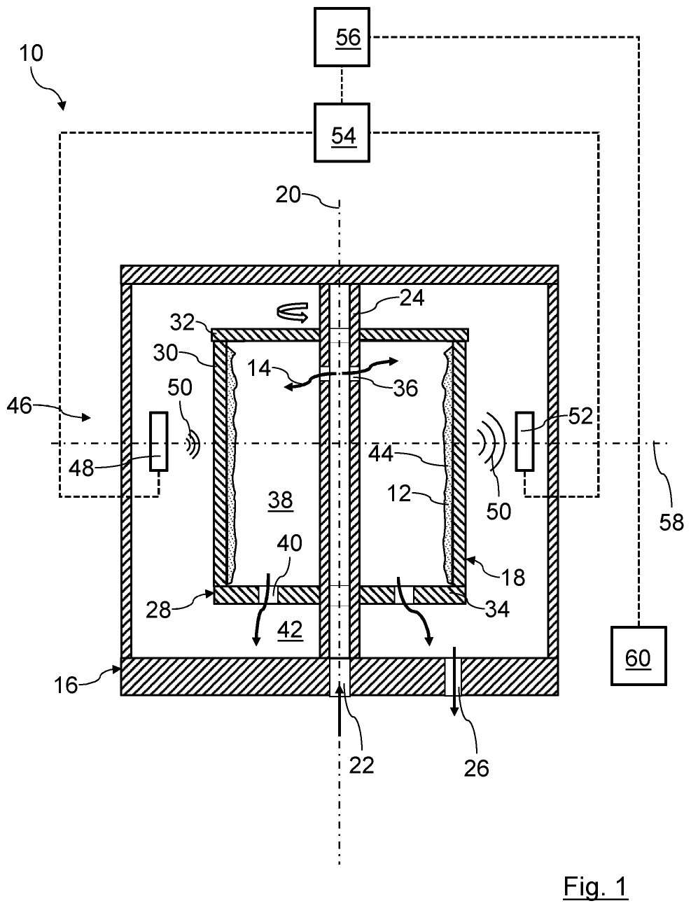

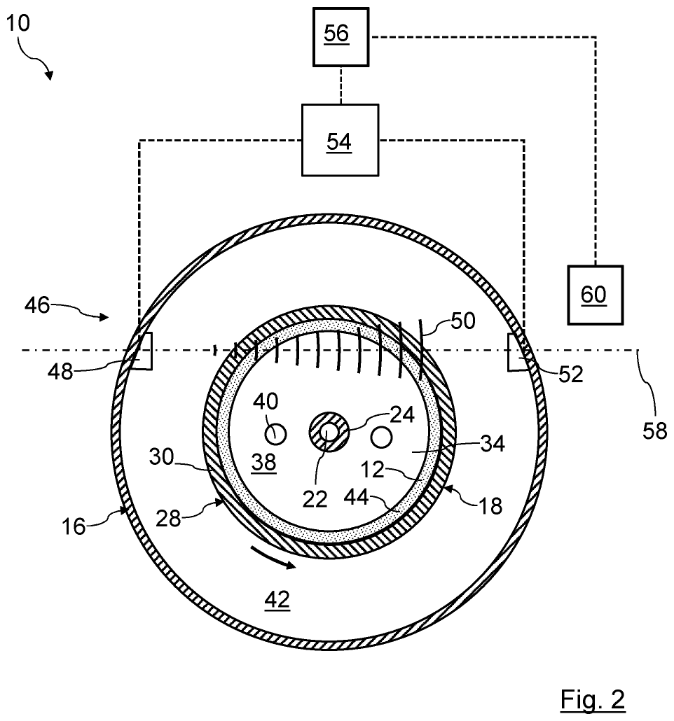

In FIGS. 1 and 2, a separation device in the form of an oil centrifuge 10 of a motor oil circuit, not illustrated otherwise, of an internal combustion engine is schematically shown in section. In an exemplary fashion, the oil centrifuge 10 is arranged in a bypass of the motor oil circuit and serves for removal of impurities like particles 12, for example, soot particles or the like, from the motor oil 14.

The oil centrifuge 10 comprises an openable centrifuge housing 16 in which a rotor 18 is exchangeably arranged. The rotor 18 is supported so as to be rotatable about a virtual rotor axis 20 in the centrifuge housing 16. Spatially, the rotor axis 20 extends vertically in the normal operating orientation of the oil centrifuge 10. It may also be arranged differently. When in the following Aradial@, Aaxial@, Acoaxial@, Acircumferential@ or the like is mentioned, this relates to the rotor axis 20, if nothing to the contrary is mentioned.

The centrifuge housing 16 has an inlet 22 for motor oil 14 to be cleaned at a bottom end face in FIG. 1. In the interior of the centrifuge housing 16, the inlet 22 is connected to an interior of a coaxial spindle 24 of the rotor 18.

The centrifuge housing 16 comprises furthermore an outlet 26 for the cleaned motor oil 14 which eccentrically extends out of the bottom end face of the centrifuge housing 16 in FIG. 1 in an exemplary fashion.

As an example, the centrifuge housing 16 can be opened by removal of a cover side, in FIG. 1 at the top, so that the rotor 18 is accessible for servicing purposes, for example, for cleaning or for exchange.

The rotor 18 is supported at the ends of the spindle 24 in the centrifuge housing 16. The rotor 18 as a whole is designed as a rotation body in relation to the rotor axis 20. It comprises a coaxial rotor housing 28, which is circular cylindrical in the embodiment, with a circumferential separation wall 30, an end face cover section 32, and an end face bottom section 34. The cover section 32 can be separated from the separation wall 30 for servicing purposes, for example, for cleaning the rotor 18.

The spindle 24 extends coaxially through the bottom section 34 and the cover section 32. In the half which is facing the cover section 32, the spindle 24 comprises in its radially outer circumferential wall a plurality of oil passages 36. The oil passages 36 connect the interior of the spindle 24 to a separation space 38 in the interior of the rotor housing 28.

The bottom section 34 comprises moreover a plurality of oil drains 40 which are arranged eccentrically to the rotor axis 20 outside of the spindle 24. The oil drains 40 connect the separation space 38 to an outlet space 42 of the centrifuge housing 16 above the bottom section 34. The outlet 26 extends outwardly out the outlet space 42.

The radially inner circumferential side of the separation wall 30 of the rotor 18 serves as collecting region 44 for the particles 12 (impurities) separated from the motor oil 14. In FIGS. 1 and 2, a so-called Acake@ of separated particles 12 is indicated, for example.

The separation wall 30 is transmissive for electromagnetic radio waves 50. For example, the separation wall 30 can be made of plastic material.

The oil centrifuge 10 comprises a load determination apparatus 46. With the load determination apparatus 46, an impurity load state of the collecting region 44 of the separation wall 30 in relation to separated particles 12 can be determined. The impurity load state indicates how much the collecting region 44 is laden with particles 12 (impurities).

The load determination apparatus 46 comprises a transmitter 48 with which directional electromagnetic radio waves 50 can be emitted. Furthermore, the load determination apparatus 46 comprises a receiver 52 with which the radio waves 50 can be received. The transmitter 48 and the receiver 52 are connected to an electronic control and evaluation device 54 of the load determination apparatus 46. The control and evaluation device 54 in turn is connected to a control unit 56 of the internal combustion engine which is otherwise not illustrated.

The transmitter 48 and the receiver 52 are fastened on opposite sides of the rotor 18 at the radially inner circumferential side of the centrifuge housing 16, respectively. Transmitter 48 and receiver 52 are encapsulated fluid-tightly, respectively.

A virtual connecting line 58 between the transmitter 48 and the receiver 52 extends tangentially to a virtual circular cylinder which is coaxial to the rotor axis 20. The connecting line 58 extends outside of, i.e., eccentrically to, the spindle 24. As an example, the transmitter 48 and the receiver 52 are located at the same axial height in relation to the rotor axis 20. The transmitter 48 and the receiver 52 are located on opposite sides of the collecting region 44. The virtual connecting line 58 crosses the separation wall 30 and the collecting region 44 twice, respectively, and extends in this context transversely through the separation space 38. The transmitter 48 is oriented toward the receiver 52. Correspondingly, the receiver 52 is oriented toward the transmitter 48.

The radio waves 50 generated by the transmitter 48 pass through the interior of the centrifuge housing 16, a first section of the separation wall 30 which is facing the transmitter 48, and the collecting region 44 arranged behind it with the particles 12 having been deposited thereat. In the separation space 38, the radio waves 50 first reach the collecting region 44 with the separated particles 12 at the other side of the separation wall 30 and pass a second section of the separation wall 30 at the side which is facing the receiver 52. Behind the second section of the separation wall 30, the radio waves 50 reach the receiver 52. Depending on the load with separated particles 12, the radio waves 50 are damped as they pass twice the collecting region 44 in the example.

With the control and evaluation device 54, damping of the radio waves 50 is determined and, based thereon, the impurity load state of the collecting region 44 with particles 12 is determined. The impurity load state is indicated in an exemplary fashion in form of a load level. The impurity load state is transmitted to the control unit 56 of the internal combustion engine. As soon as the impurity load state has surpassed a predetermined limit, a corresponding information that servicing of the oil centrifuge 10 is required is generated by the control unit 56. In an exemplary fashion, the information can be further conveyed to a corresponding output device. As an alternative or in addition, the information, as needed, can be read out.

Optionally, the oil centrifuge 10 comprises a rotary speed determination device 60 with which the rotary speed of the rotor 18 can be determined. The rotary speed determination device 60 is connected also to the control and evaluation device 54. In this manner, the rotary speed can be used in addition for the determination of the impurity load state of the rotor 18.

In operation of the oil centrifuge 10, the motor oil 14 to be cleaned is guided through the inlet 22 into the interior of the spindle 24. The motor oil 14 to be cleaned flows under pressure through the oil passages 36 into the separation space 38. Due to the repulsion, the rotor 18 is driven in rotation. Due to the rotation of the rotor 18, the heavier particles 12 are conveyed radially outwardly due to the centrifugal force and deposit in the collecting region 44 at the radially inner circumferential side of the separation wall 30 and form the cake. The motor oil which has been freed from particles 12 sinks downwardly and exits the separation space 38 through the oil drains 40. The cleaned motor oil 14 reaches the outlet space 42 and exits therefrom through the outlet 26.

During operation of the oil centrifuge 10, monitoring of the impurity load state is carried out continuously while the rotor 18 rotates.

What is claimed is:

1. A separation device for separation of impurities from a fluid to be cleaned, the separation device comprising:
at least one separation body with at least one collecting region for impurities;
at least one load determination apparatus configured to determine an impurity load state of at least one part of the at least one collecting region for impurities;
wherein the at least one load determination apparatus comprises at least one transmitter configured to emit electromagnetic waves and at least one receiver configured to receive the electromagnetic waves emitted by the at least one transmitter;
wherein the at least one load determination apparatus further comprises at least one evaluation device, wherein the at least one transmitter and the at least one receiver are connected to the at least one evaluation device;
wherein the at least one transmitter and the at least one receiver are arranged opposite each other on opposite sides of the at least one collecting region for impurities;
wherein the at least one separation body at least in sections thereof is at least partially transmissive for the electromagnetic waves emitted by the at least one transmitter;
wherein the at least one evaluation device is configured to determine the impurity load state of the at least one collecting region for impurities based on the electromagnetic waves emitted by the at least one transmitter and received by the at least one receiver.

2. The separation device according to claim 1, wherein the at least one separation device is a centrifugal separator comprising at least one rotor rotatable about a rotor axis, wherein the at least one rotor comprises a separation wall surrounding circumferentially the rotor axis and forming the separation body, wherein the separation wall comprises a radially inner circumferential side and the at least one collecting region for impurities is realized at the radially inner circumferential side, wherein at least the separation wall at least in sections thereof is at least partially transmissive for the electromagnetic waves emitted by the at least one transmitter.

3. The separation device according to claim 2, wherein the at least one transmitter is arranged radially outside of the separation wall in relation to the rotor axis and/or the at least one receiver is arranged radially outside of the separation wall in relation to the rotor axis.

4. The separation device according to claim 2, wherein the at least one rotor comprises a spindle rotatable about the rotor axis, wherein the separation wall is held rotatably at the spindle, wherein a virtual connecting line extending between the at least one transmitter and the at least one receiver extends outside of the spindle.

5. The separation device according to claim 2, wherein the centrifugal separator comprises at least one rotary speed determination device configured to determine a rotary speed of the at least one rotor.

6. The separation device according to claim 5, wherein the at least one evaluation device is an electronic evaluation device connected to the at least one rotary speed determination device and configured to determine the impurity load state based on the electromagnetic waves emitted by the at least one transmitter and received by the at least one receiver and based on the rotary speed of the at least one rotor.

7. The separation device according to claim 1, wherein the electromagnetic waves are radio waves.

8. The separation device according to claim 7, wherein the radio waves comprise frequencies in a range of 1 GHz to 60 GHz.

9. The separation device according to claim 8, wherein the frequencies are selected from one or more ranges selected from the group consisting of 2.3-2.5 GHz, 5 GHz-5.8 GHz, and 5.925 GHz-7.125 GHz.

10. The separation device according to claim 1, wherein the electromagnetic waves emitted by the at least one transmitter are directional.

11. The separation device according to claim 1, wherein at least part of the electromagnetic waves emitted by the at least one transmitter are permanent signals and/or at least part of the electromagnetic waves emitted by the at least one transmitter are pulsed signals.

12. The separation device according to claim 1, further comprising a housing, wherein the at least one transmitter and/or the at least one receiver is arranged at a housing inner side of the housing.

13. The separation device according to claim 1, wherein the at least one transmitter and/or the at least one receiver is a microcontroller comprising an integrated transmitting and/or receiving unit.

14. The separation device according to claim 1, wherein the at least one transmitter and/or the at least one receiver is encapsulated fluid-tightly.

15. A load determination apparatus for a separation device for separation of impurities from a fluid to be cleaned, the load determination apparatus comprising:
at least one transmitter configured to emit electromagnetic waves;
at least one receiver configured to receive the electromagnetic waves emitted by the at least one transmitter;
at least one evaluation device, wherein the at least one transmitter and the at least one receiver are connected to the at least one evaluation device;
wherein the at least one transmitter and the at least one receiver are configured to be arranged opposite each other on opposite sides of at least one collecting region for impurities of at least one separation body of the separation device, wherein the at least one separation body at least in sections thereof is at least partially transmissive for the electromagnetic waves emitted by the at least one transmitter;
wherein the at least one evaluation device is configured to determine an impurity load state of at least one part of the at least one collecting region for impurities based on the electromagnetic waves emitted by the at least one transmitter and received by the at least one receiver.

16. A method for determining an impurity load state of at least one part of at least one collecting region for impurities of at least one separation body of at least one separation device for separation of impurities from a fluid to be cleaned, the method comprising:
sending electromagnetic waves by at least one transmitter through the at least one part of the at least one collecting region for impurities;
receiving the electromagnetic waves passing through the at least one part of the at least one collecting region for impurities by at least one receiver arranged at an opposite side of the at least one separation body opposite the at least one transmitter in relation to the at least one collecting region; and
determining by at least one evaluation device an impurity load state of the at least one part of the at least one collecting region for impurities based on the electromagnetic waves received by the at least one receiver.
